(19) United States
(12) Patent Application Publication
(10) Pub. No.: US 2026/0227898 A1
(43) Pub. Date: Aug. 6, 2026

(54) PAGE RENDERING METHOD, APPARATUS, DEVICE, AND STORAGE MEDIUM

(71) Applicant: Beijing Zitiao Network Technology Co., Ltd., Beijing (CN)

(72) Inventors: Maoqi LI, Beijing (CN); Xiaoke YANG, Beijing (CN); Jinsong ZOU, Beijing (CN); Bingyang XIE, Beijing (CN)

(21) Appl. No.: 19/152,656

(22) PCT Filed: Feb. 2, 2024
(86) PCT No.: PCT/CN2024/075406

§ 371 Date: Jul. 31, 2025

(30) Foreign Application Priority Data
Feb. 2, 2023 (CN) 202310120171.7

(51) Int. Cl. G06F 3/0485; G06F 3/0486

(52) U.S. Cl. CPC G06F 3/0485; G06F 3/0486

(57) ABSTRACT

Provided in embodiments of the present disclosure are a page rendering method and apparatus, a device and a storage medium. A scrolling operation triggered by a user on a current page is monitored, and a visible area is determined on the basis of the monitored scrolling operation, the scrolling operation comprising transverse scrolling or longitudinal scrolling; a plurality of pieces of target service data corresponding to the visual area are obtained, the plurality of pieces of target service data having a topological structure relationship; position information of the plurality of pieces of target service data in the visual area is determined according to the topological structure relationship; and the plurality of pieces of target service data are, on the basis of the position information, rendered to the current page for display.

### CROSS-REFERENCE TO RELATED APPLICATIONS

The present application claims priority to and is based on a Chinese application with an application number 202310120171.7, filed on Feb. 2, 2023, and entitled “PAGE RENDERING METHOD, APPARATUS, DEVICE, AND STORAGE MEDIUM”, the aforementioned application is hereby incorporated by reference in its entirety.

### TECHNICAL FIELD

Embodiments of the present disclosure relate to the technical field of page rendering, and in particular, to a page rendering method and apparatus, a device, and a storage medium.

### BACKGROUND

At present, various structures, such as a table structure, a Gantt chart structure, and a tree structure, may be used for data display in a page. Among them, the tree structure may be freely folded and expanded, and thus may accommodate more information in a limited space, and therefore is widely used for view display.

### SUMMARY

Embodiments of the present disclosure provide a page rendering method and apparatus, a device, and a storage medium, which can render service data to a page according to a topological structure relationship, so that the displayed service data is presented in a hierarchical style, thereby improving diversity of service data display and convenience of data maintenance.

In a first aspect, an embodiment of the present disclosure provides a page rendering method, including:
monitoring a scrolling operation triggered by a user on a current page, and determining a visible region based on the monitored scrolling operation, wherein the scrolling operation includes lateral scrolling or longitudinal scrolling;
acquiring a plurality of pieces of target service data corresponding to the visible region, where the plurality of pieces of target service data have a topological structure relationship thereamong;
determining position information of the plurality of pieces of service data in the visible region according to the topological structure relationship; and
rendering the plurality of pieces of service data to the current page for display based on the position information.

In a second aspect, an embodiment of the present disclosure further provides a page rendering apparatus, including:
a visible region determination module, configured to monitor a scrolling operation triggered by a user on a current page, and determine a visible region based on the monitored scrolling operation, where the scrolling operation includes lateral scrolling or longitudinal scrolling;
a target service data acquisition module, configured to acquire a plurality of pieces of target service data corresponding to the visible region, where the plurality of pieces of target service data have a topological structure relationship thereamong;
a position information determination module, configured to determine position information of the plurality of pieces of service data in the visible region according to the topological structure relationship; and
a rendering module, configured to render the plurality of pieces of service data to the current page for display based on the position information.

In a third aspect, an embodiment of the present disclosure further provides an electronic device, including:
one or more processors; and
a storage device, configured to store one or more programs,
wherein the one or more programs, when executed by the one or more processors, cause the one or more processors to implement the page rendering method according to the embodiments of the present disclosure.

In a fourth aspect, an embodiment of the present disclosure further provides a storage medium including computer-executable instructions, wherein the computer-executable instructions, when executed by a computer processor, are configured to execute the page rendering method according to the embodiments of the present disclosure.

### BRIEF DESCRIPTION OF THE DRAWINGS

The above and other features, advantages, and aspects of embodiments of the present disclosure become more apparent with reference to the following detailed description and in conjunction with the drawings. Throughout the drawings, the same or similar reference numbers refer to the same or similar elements. It should be understood that the drawings are schematic, and original components and elements are not necessarily drawn to scale.

FIG. 1a is a flowchart of a page rendering method according to an embodiment of the present disclosure;

FIG. 1b is a signaling diagram of acquiring target service data in the embodiment;

FIG. 2a is a topological structure diagram of target service data according to an embodiment of the present disclosure;

FIG. 2b is a topological structure diagram of target service data according to an embodiment of the present disclosure;

FIG. 2c is an effect diagram of rendering target service data according to an embodiment of the present disclosure;

FIG. 3a is a schematic diagram of a system service data topology graph according to an embodiment of the present disclosure;

FIG. 3b is a schematic diagram of a configuration page according to an embodiment of the present disclosure;

FIG. 3c is a schematic structural diagram of an initial service data topology graph according to an embodiment of the present disclosure;

FIG. 4a is a schematic diagram of a system service data topology graph and an initial service data topology graph according to an embodiment of the present disclosure;

FIG. 4b is a schematic diagram of a service data topology subgraph according to an embodiment of the present disclosure;

FIG. 4c is a schematic diagram of a filtered service data topology subgraph according to an embodiment of the present disclosure;

FIG. 4d is a schematic diagram of a second candidate service data topology subgraph according to an embodiment of the present disclosure;

FIG. 4e is a schematic diagram of a target service data topology graph according to an embodiment of the present disclosure;

FIG. 5 is a schematic structural diagram of a page rendering apparatus according to an embodiment of the present disclosure; and

FIG. 6 is a schematic structural diagram of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that various steps described in the method implementations of the present disclosure may be performed in different orders and/or in parallel. In addition, the method implementations may include additional steps and/or omit performing the illustrated steps. The scope of the present disclosure is not limited in this respect.

As used herein, the term “include/comprise” and its variants are open-ended inclusions, that is, “include/comprise but not limited to”. The term “based on” is “at least partially based on”. The term “one embodiment” means “at least one embodiment”. The term “another embodiment” means “at least one another embodiment”. The term “some embodiments” means “at least some embodiments”. Related definitions of other terms will be given in the following description.

It should be noted that concepts such as “first” and “second” mentioned in the present disclosure are only used to distinguish between different apparatuses, modules or units, and are not used to limit the order or interdependence of functions performed by these apparatuses, modules or units.

It should be noted that the modifications of “one” and “a plurality of” mentioned in the present disclosure are schematic rather than restrictive. Those skilled in the art should understand that they should be regarded as “one or more” unless the context clearly indicates otherwise.

The names of messages or information exchanged between apparatuses in the implementations of the present disclosure are only used for illustrative, and are not intended to limit the scope of these messages or information.

It may be understood that, before using the technical solutions disclosed in the embodiments of the present disclosure, the user should be informed of the type, usage scope, usage scenario, etc. of the personal information involved in the present disclosure in an appropriate manner and the user's authorization should be obtained in accordance with relevant laws and regulations.

For example, when receiving an active request from the user, prompt information is sent to the user to explicitly prompt the user that the operation requested to be performed will require the acquisition and usage of the user's personal information. In this way, the user can autonomously select whether to provide the personal information to software or hardware such as an electronic device, an application, a server or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide personal information to the electronic device.

It may be understood that the above process of notifying and obtaining the user's authorization is only schematic, and does not constitute a limitation on the implementations of the present disclosure. Other manners that meet relevant laws and regulations may also be applied to the implementations of the present disclosure.

It may be understood that the data involved in the technical solution (including but not limited to the data itself, the acquisition or use of the data) should comply with the requirements of corresponding laws and regulations and related provisions.

The existing tree view function is relatively simple in display and interaction, and cannot meet the requirements of complex service data.

Embodiments of the present disclosure provide a page rendering method and apparatus, a device, and a storage medium. A scrolling operation triggered by a user on a current page is monitored, and a visible region is determined based on the monitored scrolling operation, wherein the scrolling operation includes lateral scrolling or longitudinal scrolling; a plurality of pieces of target service data corresponding to the visible region are acquired, wherein the plurality of pieces of target service data have a topological structure relationship thereamong; position information of the plurality of pieces of service data in the visible region is determined according to the topological structure relationship; and the plurality of pieces of service data are rendered to the current page for display based on the position information. According to the page rendering method provided in the embodiment, the plurality of pieces of target service data corresponding to the visible region are rendered to the page based on the topological structure relationship, so that the displayed service data is presented in a hierarchical style, thereby improving the diversity of service data display and the convenience of data maintenance.

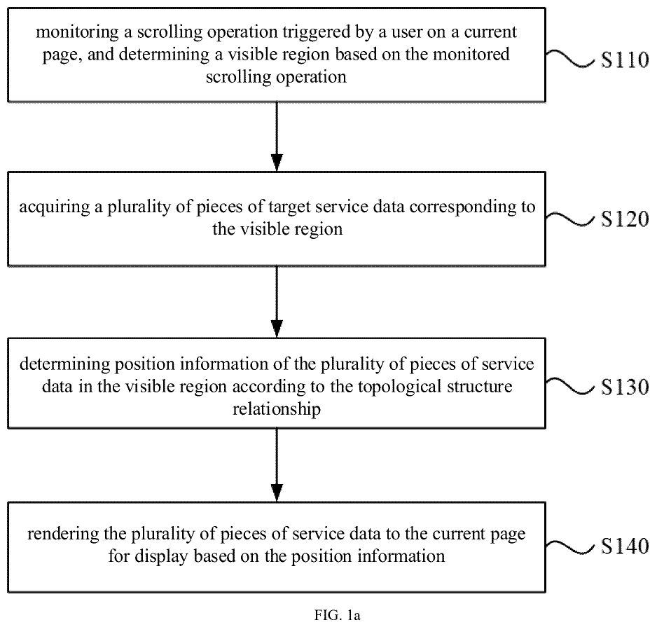

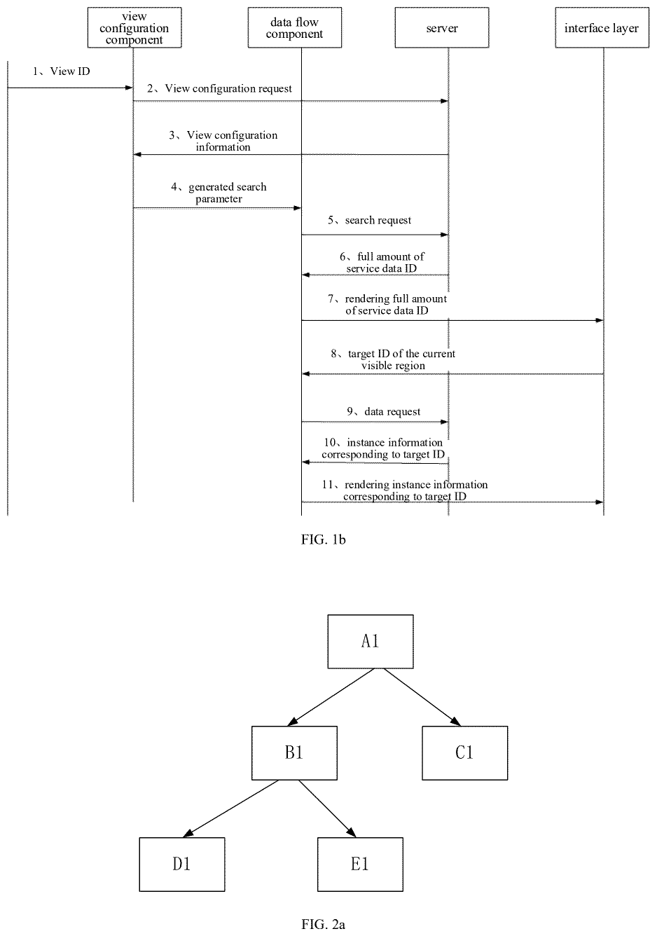

FIG. 1a is a flowchart of a page rendering method according to an embodiment of the present disclosure, the embodiment of the present disclosure is applicable to a situation of rendering a page, the method may be executed by a page rendering apparatus, the apparatus may be implemented in form of software and/or hardware, optionally, the apparatus may be implemented by an electronic device, the electronic device may be a mobile terminal, a personal computer (PC) terminal, a server, or the like.

As shown in FIG. 1a, the method includes the following steps.

S110, a scrolling operation triggered by a user on a current page is monitored, and a visible region is determined based on the monitored scrolling operation.

The scrolling operation includes lateral scrolling or longitudinal scrolling. In the embodiment, a scroll control may be used to monitor the scrolling operation triggered by the user on the current page. For example, the scroll control may be a view scroll control (ScrollView), which has its own scroll bar and supports hiding the scroll bar. The principle of monitoring the scrolling operation triggered by the user on the current page may be regarded as detecting a position to which the scroll bar moves.

The visible region may be regarded as a region displayed on the current page, and the process of determining the visible region may be regarded as a process of determining boundary coordinate information of the visible region. In some embodiments, the process of determining the visible region based on the monitored scrolling operation may be: when the scrolling operation is longitudinal scrolling, acquiring longitudinal coordinates of a current position of the scroll bar, and determining longitudinal coordinates of upper and lower boundaries of the visible region based on the longitudinal coordinates of the current position of the scroll bar, so as to obtain the position of the visible region; and when the scrolling operation is lateral scrolling, acquiring lateral coordinates of the current position of the scroll bar, and determining lateral coordinates of left and right boundaries of the visible region based on the lateral coordinates of the current position of the scroll bar, so as to obtain the position of the visible region. In the embodiment, the principle of monitoring the scrolling operation triggered by the user on the current page may refer to the working principle of the existing ScrollView control, which is not limited here.

In S120, a plurality of pieces of target service data corresponding to the visible region are acquired.

The plurality of pieces of target service data have the topological structure relationship thereamong. The topological structure relationship may be a tree structure relationship, and the tree structure may be regarded as a hierarchical nested structure, in the embodiment, the technology will be explained by taking the tree structure as an example. After the topological structure relationship among the pieces of target service data has been acquired, hierarchical information of each piece of target service data and target service data at an upper level and target service data at a lower level that are associated with the piece of target service data, that is, the hierarchical information of each piece of target service data and its parent node and child node, may be acquired.

The target service data may include target identification information (Identity document, ID) and target attribute information. In the embodiment, the process of acquiring the plurality of pieces of target service data corresponding to the visible region may be regarded as a process of loading the plurality of pieces of target service data corresponding to the visible region. In the embodiment, the target identification information and the target attribute information can be loaded twice, that is, the target identification information can be loaded first, and then the target attribute information can be loaded.

Optionally, before the scrolling operation triggered by the user on the current page is monitored, the method further includes the following step: loading identification information of full amount of service data of the current page.

The full amount of service data may be regarded as all service data that may be displayed on the current page. In the embodiment, when the user opens the current page for the first time, a view component first sends a page request to a data source, and the data source returns identification information of the full amount of service data on the page to the view component according to the page request, and caches the identification information of the full amount of service data. In the embodiment, since the identification information occupies a very small memory space, even if the identification information of the full amount of service data is requested, there is no impact on the memory.

Correspondingly, the process of acquiring the plurality of pieces of service data corresponding to the visible region may be: acquiring a plurality of pieces of target identification information corresponding to the visible region from the identification information based on a set mapping relationship; and loading a plurality of pieces of target attribute information based on the plurality of pieces of target identification information.

The set mapping relationship may be regarded as a mapping relationship between the visible region and the service data. In the embodiment, since the visible region is characterized by boundary coordinate information, after the boundary coordinate information of the visible region is acquired, it may be obtained which service data is covered by the visible region. For example, one visible region covers 100th to 200th pieces of service data, and another visible region covers 150th to 250th pieces of service data.

Exemplarily, FIG. 1b is a signaling diagram of acquiring the target service data in the embodiment, as shown in FIG. 1b, the process includes the following steps.
1) a view configuration component acquires a view ID, and generates a configuration request according to the view ID;
2) the view configuration request is sent to a server;
3) the server returns view configuration information according to the view configuration request;
4) the view configuration component sends a generated search parameter to a data flow component;
5) the data flow component sends a search request to the server according to the search parameter;
6) the server returns an ID of the full amount of service data of the view (which may also be referred to as page skeleton information) to the data flow component according to the search request;
7) the data flow component sends the ID of the full amount of service data to an interface layer for rendering;
8) the interface layer sends a target ID corresponding to a current visible region to the data flow component;
9) the data flow component sends a data request to the server based on the target ID;
10) the server returns attribute information corresponding to the target ID (referred to as instance information in the figure) according to the data request; and
11) the attribute information corresponding to the target ID is sent to the interface layer for rendering.

In some embodiments, after the visible region is determined, a plurality of pieces of target identification information may be acquired from the cached identification information of the full amount of service data according to the visible region, the view component sends the plurality of pieces of target identification information to the data source, and the data source returns the plurality of pieces of target attribute information corresponding to the plurality of pieces of target identification information to the view component. In the embodiment, only the target attribute information required by the visible region needs to be loaded, thereby implementing lazy loading of the target attribute information, that is, only loading data currently needed, saving memory resources, and reducing loading of useless resources.

Optionally, after the plurality of pieces of target attribute information are loaded according to the plurality of pieces of target identification information, the method further includes the following steps: determining a predicted visible region; and loading prediction attribute information corresponding to the predicted visible region.

The predicted visible region may be regarded as a visible region that is predicted to be scrolled to based on a scrolling trend of the scrolling operation triggered by the user. The predicted visible region may be determined by: first acquiring direction and speed of the scrolling operation triggered by the current user, and then inputting the direction and speed of the scrolling operation into a set prediction algorithm to obtain the predicted visible region. The process of loading the prediction attribute information corresponding to the predicted visible region may be: first acquiring a plurality of pieces of prediction identification information from the cached identification information of the full amount of service data according to the predicted visible region, the view component sends the plurality of pieces of prediction identification information to the data source, the data source returns a plurality of pieces of prediction attribute information corresponding to the plurality of pieces of prediction identification information to the view component, and caches the plurality of pieces of prediction attribute information.

In the embodiment, the visible region is predicted, so that the attribute information may be preloaded, when the actual visible region overlaps or partially overlaps with the predicted visible region, the service data that has been loaded may be directly used, thereby reducing the waiting time for loading data and improving the user experience.

In S130, position information of the plurality of pieces of target service data in the visible region is determined according to the topological structure relationship.

The topological structure relationship records the hierarchical information of each piece of target service data and the association relationship between the pieces of target service data. In the embodiment, the plurality of pieces of service data need to be displayed on the current interface in the form of a list. The form of the list may be regarded as: one piece of target service data occupies one row or one column, and the target identification information and the target attribute information are displayed in corresponding columns or rows in a certain order. In the embodiment, the target identification information may be placed at the first place. In order to match the displayed target service data with its topological structure relationship, different hierarchical information may correspond to different indent information, and the indent information is inversely proportional to the hierarchical information, that is, the higher the hierarchy, the smaller the indent information, and the lower the hierarchy, the larger the indent information. In the embodiment, the level where the root node is located is the highest.

In some embodiments, the manner of determining the position information of the plurality of pieces of target service data in the visible region according to the topological structure relationship may be: determining the hierarchical information of each piece of target service data according to the topological structure relationship; and determining position information of a cell where the target service data is located according to the hierarchical information.

The cell is a row cell or a column cell, and the position information of the cell may be regarded as position information of a left vertex of the cell. In the embodiment, a list view (ListView) control may be used to render the target service data. Each row of cells in the ListView is used to display one piece of target service data, and each row of cells is divided into two parts, the left part is a header, and the right part is a body.

When the cell is a row cell, the position information of the cell includes longitudinal position information and lateral indent information; and when the cell is a column cell, the position information of the cell includes lateral position information and longitudinal indent information.

In some embodiments, when the cell is a row cell, the row height of the row cell needs to be configured. The process of determining the position information of the cell where the target service data is located according to the hierarchical information may be: first determining an order of the target service data in the topology according to the hierarchical information, then determining the longitudinal coordinate of its corresponding cell according to the order and the row height, then determining the lateral indent information of the cell according to the hierarchical information, and determining the lateral coordinate based on the lateral indent information, where the lateral coordinate and the longitudinal coordinate constitute the position information of the cell. In the embodiment, for the target service data at the same level, the lateral indent information of the cells where they are located is the same.

In some embodiments, when the cell is a column cell, the column width of the column cell needs to be configured. The process of determining the position information of the cell where the target service data is located according to the hierarchical information may be: first determining an order of the target service data in the topology according to the hierarchical information, then determining the lateral coordinate of its corresponding cell according to the order and the column width, then determining the longitudinal indent information of the cell according to the hierarchical information, and determining the longitudinal coordinate based on the longitudinal indent information, where the lateral coordinate and the longitudinal coordinate constitute the position information of the cell. In the embodiment, for the target service data at the same level, the longitudinal indent information of the cells where they are located is the same.

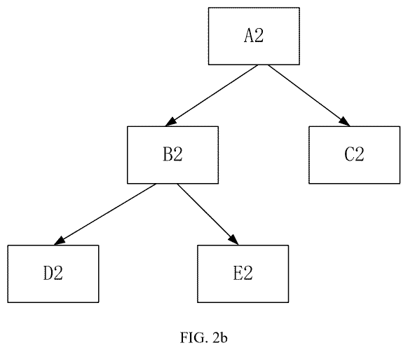

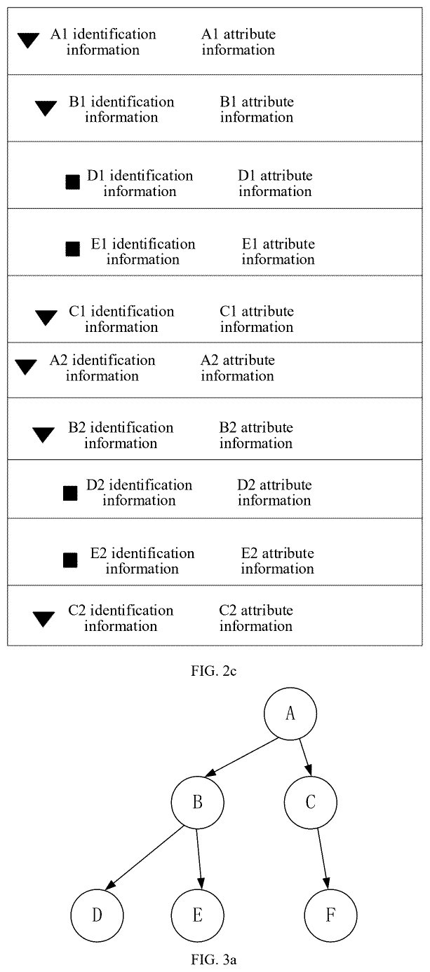

In this embodiment, taking the row cell as an example, assuming that the set row height is h, and the sequence number (starting from 0) is represented by n, for each piece of target service data, the longitudinal coordinate of its corresponding cell determined according to the order and the row height may be represented as: y=h*n. Assuming that an indent coefficient is β, and the hierarchical information is represented as m, the lateral coordinate determined by the lateral indent information may be represented as: x=(m−1)* β. Exemplarily, assuming that the determined target service data includes A1, B1, C1, D1, E1, A2, B2, C2, D2 and E23. FIG. 2a and FIG. 2b are topological structure diagrams of the target service data. As shown in FIG. 2a, A1 is a root node, B1 and C1 are child nodes of A1, and D1 and E1 are child nodes of B1. As shown in FIG. 2b, A2 is a root node, B2 and C2 are child nodes of A2, and D2 and E2 are child nodes of B2. Among them, A1 and A2 are at a level, B1, B2, C1 and C2 are at a second level, and D1, E2, D2 and E2 are at a third level. The sequence of the target service data is A1-B1-C1-D1-E1-A2-B2-C2-D2-E2. Exemplarily, for E1, its sequence number is 4, and it is at the third level, and then the longitudinal coordinate of the cell where it is located is: y=4h, and the lateral coordinate of the cell is: x=(3−1)*. FIG. 2c is a rendering diagram of the target service data. As shown in FIG. 2c, A1 and A2 have the same indent size, B1, B2, C1 and C2 have the same indent size, and D1, E2, D2 and E2 have the same indent size. In this embodiment, the position information of the cell where the target service data is located can be determined according to the hierarchical information, so that the displayed target instance data matches with the topology, which not only improves the diversity of data display, but also provides a user-friendly data interface diagram with low editing cost.

In S140, the plurality of pieces of target service data are rendered to the current page for display based on the position information.

In some embodiments, after the position information of the cell where each piece of target service data is located is obtained, the target service data is rendered into a corresponding cell based on the position information.

In the embodiment, since the loading of the target identification information precedes the loading of the target attribute information, the target identification information may be rendered first, and then the target attribute information is rendered. The solution of the embodiment supports the display of massive data at one time.

In the embodiment, a canvas rendering mode may be used to render the target service data.

According to the technical solution of the embodiment of the present disclosure, a scrolling operation triggered by a user on a current page is monitored, and a visible region is determined based on the monitored scrolling operation, where the scrolling operation includes lateral scrolling or longitudinal scrolling; a plurality of pieces of target service data corresponding to the visible region are acquired, where the plurality of pieces of target service data have a topological structure relationship; position information of the plurality of pieces of service data in the visible region is determined according to the topological structure relationship; and the plurality of pieces of service data are rendered to the current page for display based on the position information. According to the page rendering method provided in the embodiment, the plurality of pieces of target service data corresponding to the visible region are rendered to the page based on the topological structure relationship, so that the displayed service data is presented in a hierarchical style, thereby supporting the display of massive data at one time, and improving the diversity of service data display and the convenience of data maintenance.

Optionally, before the scrolling operation triggered by the user on the current page is monitored, the method further includes the following steps: receiving an initial service data topology configured by the user; and fusing the initial service data topology with a system service data topology to obtain a target service data topology.

The initial service data topology may be a topology which is obtained by the user selecting at least one piece of service data from system service data, and hierarchically configuring the selected at least one piece of service data based on service requirements. The system service data may be service data preset for a current service, and these system service data may be called by the user.

In the embodiment, the initial service data topology configured by the user may not match with a logic between the system service data, and therefore the initial service data topology and the system service data topology need to be fused to obtain a final service data topology, that is, the target service data topology. In the embodiment, the initial service data topology and the system service data topology are fused to ensure the accuracy of the configured service data topology.

In some embodiments, the process of receiving the initial service data topology configured by the user may be: displaying the system service data topology in a resource panel; dragging at least one piece of service data selected by the user from the resource panel to a configuration panel based on a drag-and-drop operation of the user; receiving a hierarchical relationship configured by the user for the at least one piece of service data in the configuration panel; and generating the initial service data topology based on the hierarchical relationship.

The resource panel and the configuration panel may be on the same page, which may be referred to as a configuration page, the resource panel and the configuration panel are located in different regions, the resource panel is used to display system service data, and the configuration panel is used to receive a configuration operation from the user, to generate the initial service data topology. The system service data topology can be displayed in the resource panel in the form of a list, that is, there is a hierarchical relationship between the pieces of system service data, and the system service data is displayed in the resource panel in the form of a list according to the order of the hierarchical relationship. In the embodiment, the attribute information of each piece of system service data is also displayed in the resource list for the user to select and configure.

The process of displaying the system service data topology in the resource panel may be: rendering the system service data topology to the resource panel. In the embodiment, the resource panel may be rendered in a page (dom) rendering mode, and the configuration panel may be rendered in a canvas mode.

The principle of dragging the service data from the resource panel to the configuration panel may be that a canvas component in the configuration panel monitors a drag start event, a drag over event, and a drop event in the resource panel, and then distributes the monitored events to child components inside the canvas.

Optionally, the process of receiving the hierarchical relationship configured by the user for the at least one piece of service data in the configuration panel may be: receiving a movement operation of the user for the at least one piece of service data in the configuration panel; and configuring the hierarchical relationship based on the movement operation.

The movement operation may be regarded as a drag operation in the configuration panel, which may be realized by simulating a mouse down event, a mouse move event, and a mouse up event. In the embodiment, the user may arbitrarily move the selected service data to realize the configuration of the hierarchical relationship. In the embodiment, the user may configure the service data topology in the configuration page according to service requirements, may arbitrarily adjust the hierarchy of the service data, and improve the flexibility of configuration.

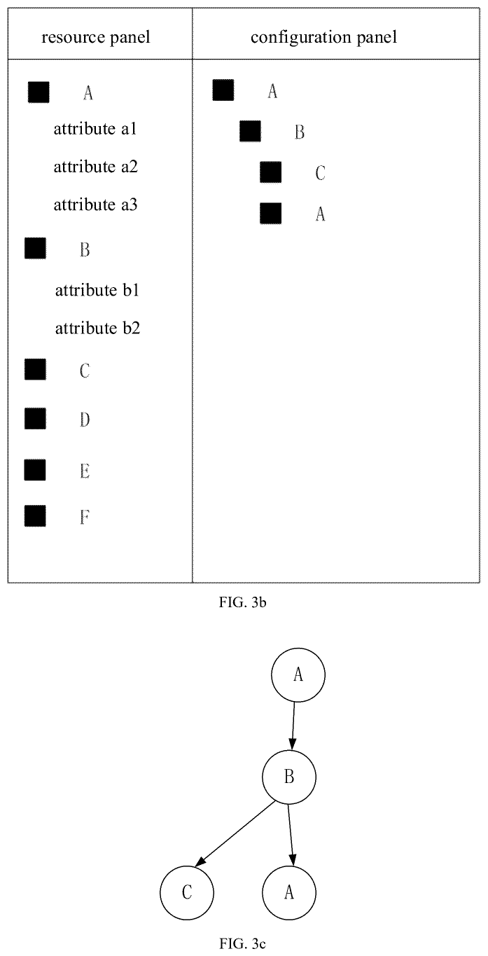

Exemplarily, FIG. 3a is a schematic diagram of a system service data topology, as shown in FIG. 3a, A is a root node, B and C are child nodes of A, D and E are child nodes of B, and F is a child node of C. FIG. 3b is a schematic diagram of a configuration page. As shown in FIG. 3b, the left area is a resource panel, which contains system service data displayed in the form of a list, and the configuration panel may receive a configuration operation triggered by the user. As shown in FIG. 3b, in the resource panel, the attribute information of each piece of system service data may also be displayed, where “A” includes attribute a1, attribute a2, and attribute a3; “B” includes attribute b1 and attribute B2, and the attribute information of “C”, “D”, “E” and “F” is not displayed in an expanded manner. In the embodiment, in the resource panel, each piece of system service data is provided with an expand/collapse button, and the user may expand or collapse the attribute information of the system service data by clicking the expand/collapse button. As shown in FIG. 3b, in the configuration panel, the service data selected by the user includes: two “A”, one “B” and one “C”, where one “A” is at the first level, another “A” is at the third level, “B” is at the second level, and “C” is at the third level. FIG. 3c is a schematic structural diagram of an initial service data topology in the embodiment, as shown in FIG. 3c, the topology is constructed based on the configuration of the user in FIG. 3b, as shown in FIG. 3c, one of “A” is a root node, “B” is a child node of “A”, and another “A” and “C” are both child nodes of “B”.

In some embodiments, the process of fusing the initial service data topology with the system service data topology to obtain the target service data topology may be: extracting a plurality of service data topology subgraphs that meet a set condition from the system service data topology; filtering the plurality of service data topology subgraphs to obtain first candidate service data topology subgraphs; merging the first candidate service data topology subgraphs to obtain a second candidate service data topology subgraph; and cropping the second candidate service data topology subgraph based on the initial service data topology to obtain the target service data topology.

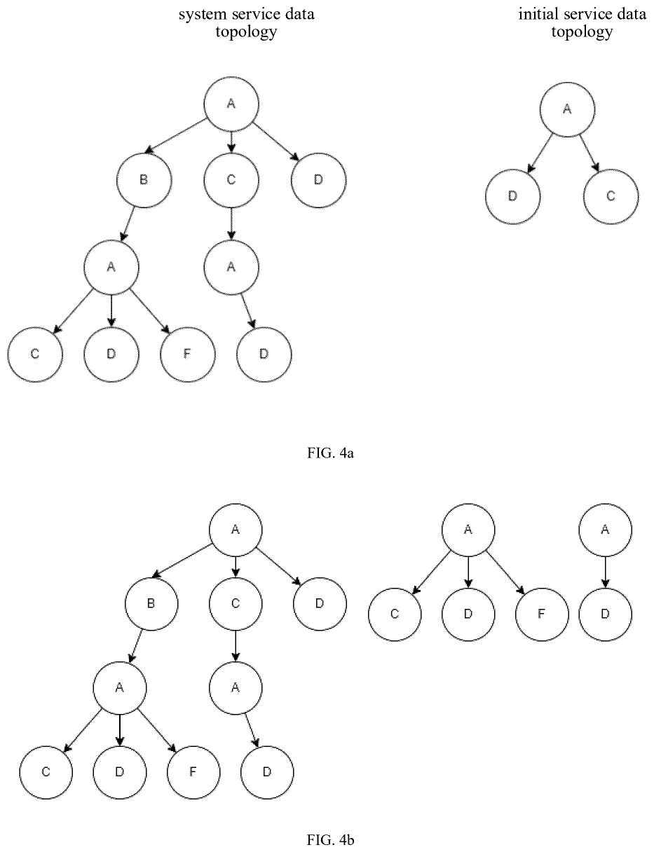

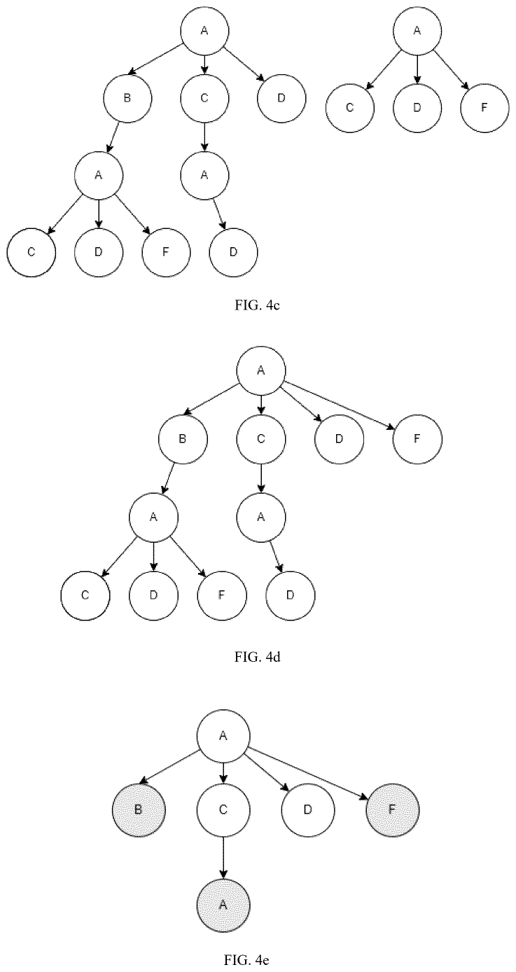

The set condition may be that a root node of the service data topology subgraph is the same as a root node of the initial service data topology, that is, the service data corresponding to the root node of the service data topology subgraph is the same as the service data corresponding to the root node of the initial service data topology. In the embodiment, in the service data topology, the same service data may be located at different levels, and therefore at least one service data topology subgraph that meets the set condition may be extracted. Exemplarily, FIG. 4a is a schematic diagram of the system service data topology and the initial service data topology in this embodiment. As shown in FIG. 4a, the root node of the initial service data topology is A, and then the service data topology subgraph with the root node A can be extracted from the system service data topology. FIG. 4b is a schematic diagram of the service data topology subgraph, as shown in FIG. 4b, three service data topology subgraphs can be extracted, and the root nodes of the three service data topology subgraphs are all A.

In some embodiments, the manner of filtering the plurality of service data topology subgraphs to obtain the first candidate service data topology subgraphs may be: filtering out a service data topology subgraph that does not contain the initial service data topology.

Not contain the initial service data topology may be regarded as Not contain a complete topology of the initial service data topology. As shown in FIG. 4a and FIG. 4b, among the three service data topology subgraphs as shown in FIG. 4b, the rightmost service data topology subgraph does not contain the initial service data topology, then the service data topology subgraph is deleted. FIG. 4c shows filtered service data topology subgraphs. As shown in FIG. 4c, two service data topology subgraphs remain after filtering.

In some embodiments, the manner of merging the first candidate service data topology subgraph to obtain the second candidate service data topology subgraph may be: deduplicating and merging the first candidate service data topology subgraph starting from the root node, to obtain the second candidate service data topology subgraph.

The deduplicating and merging starting from the root node may be regarded as: deduplicating and merging the service data at the same level to merge the first candidate service data topology subgraphs into one second candidate service data topology subgraph. Exemplarily, for two first candidate service data topology subgraphs in FIG. 4c, deduplicating and merging are performed starting from the root node, and the first levels are all A, then deduplication is performed on A; at the second level, there are duplicate C and D, and deduplication is performed on C and D, and finally B, C, D and F remain at the second level; the right first candidate service data topology subgraph does not have the third level and the fourth level, therefore the third level and the fourth level of the left first candidate service data topology subgraph are directly retained, thereby obtaining the second candidate service data topology subgraph in FIG. 4d.

In some embodiments, the manner of cropping the second candidate service data topology subgraph based on the initial service data topology to obtain the target service data topology may be: acquiring a corresponding node between the initial service data topology and the second candidate service data topology subgraph; and cropping out N-level child nodes of the corresponding node of the second candidate service data topology subgraph.

N is a positive integer greater than 1. Cropping out the N-level child nodes of the corresponding node of the second candidate service data topology subgraph may be regarded as: only retaining a first-level child node of the corresponding node. Exemplarily, for the second candidate service data topology subgraph in FIG. 4d, its root node A corresponds to the root node A in the initial service data topology, so only the first-level child node of the root node A is retained, and for C and D at the second level in the second candidate service data topology subgraph, which correspond to C and D at the second level in the initial service data topology, only the first-level child nodes of C and D at the second level are retained, and finally the target service data topology shown in FIG. 4e is obtained.

In the embodiment, the initial service data topology and the system service data topology can be fused, so that the accuracy of the generated target service data topology may be improved.

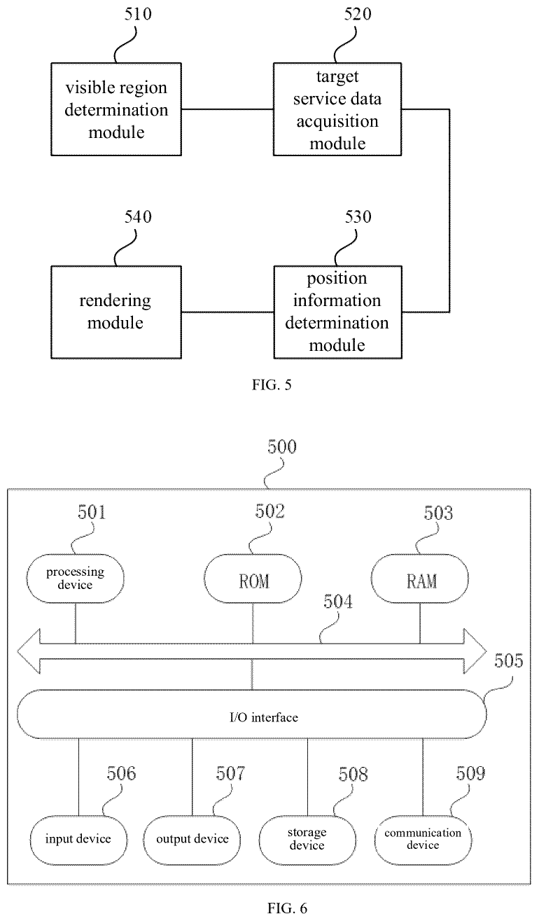

FIG. 5 is a schematic structural diagram of a page rendering apparatus according to an embodiment of the present disclosure. As shown in FIG. 5, the apparatus includes:
a visible region determining module 510, configured to monitor a scrolling operation triggered by a user on a current page, and determine a visible region based on the monitored scrolling operation, where the scrolling operation includes lateral scrolling or longitudinal scrolling;
a target service data acquisition module 520, configured to acquire a plurality of pieces of target service data corresponding to the visible region, where the plurality of pieces of target service data have a topological structure relationship thereamong;
a position information determination module 530, configured to determine position information of the plurality of pieces of service data in the visible region according to the topological structure relationship; and
a rendering module 540, configured to render the plurality of pieces of service data to the current page for display based on the position information.

Optionally, the position information determination module 530 is further configured to:
determine hierarchical information of each piece of target service data according to the topological structure relationship; and
determine position information of a cell where the target service data is located according to the hierarchical information, where the cell is a row cell or a column cell; and
the rendering the plurality of pieces of service data to the current page for display based on the position information includes:
rendering the target service data to a corresponding cell based on the position information.

Optionally, when the cell is a row cell, the position information of the cell includes longitudinal position information and lateral indent information; and when the cell is a column cell, the position information of the cell includes lateral position information and longitudinal indent information.

Optionally, the apparatus further includes a topology configuration module, configured to:
receive an initial service data topology configured by a user; and
fuse the initial service data topology with a system service data topology to obtain a target service data topology.

Optionally, the topology configuration module is further configured to:
display the system service data topology in a resource panel;
drag at least one piece of service data selected by the user from the resource panel to a configuration panel based on a drag-and-drop operation of the user;
receive a hierarchical relationship configured by the user for the at least one piece of service data in the configuration panel; and
generate the initial service data topology based on the hierarchical relationship.

Optionally, the topology configuration module is further configured to:
receive a movement operation of the user for the at least one piece of service data in the configuration panel; and
configure the hierarchical relationship based on the movement operation.

Optionally, the topology configuration module is further configured to:
extract a plurality of service data topology subgraphs that meet a set condition from the system service data topology, where the set condition is that a root node of the service data topology subgraph is the same as a root node of the initial service data topology;
filter the plurality of service data topology subgraphs to obtain first candidate service data topology subgraphs;
merge the first candidate service data topology subgraphs to obtain a second candidate service data topology subgraph; and
crop the second candidate service data topology subgraph based on the initial service data topology to obtain the target service data topology.

Optionally, the topology configuration module is further configured to:
filter out a service data topology subgraph that does not contain the initial service data topology.

Optionally, the topology configuration module is further configured to:
deduplicate and merge the first candidate service data topology subgraphs starting from the root node to obtain the second candidate service data topology subgraph; and
cropping the second candidate service data topology subgraph based on the initial service data topology to obtain the target service data topology, including:
acquiring a corresponding node between the initial service data topology and the second candidate service data topology subgraph; and
cropping out a N-level child node of the corresponding node of the second candidate service data topology subgraph to obtain the target service data topology, where N is a positive integer greater than 1.

Optionally, the target service data acquisition module 520 is further configured to:
load identification information of full amount of service data of the current page;
acquire a plurality of pieces of target identification information corresponding to the visible region from the identification information based on a set mapping relationship, where the set mapping relationship is a mapping relationship between the visible region and the service data; and
load a plurality of pieces of target attribute information based on the plurality of pieces of target identification information.

Optionally, the apparatus further includes a predicted visible region determination module, configured to:
determine a predicted visible region; and
load prediction attribute information corresponding to the predicted visible region.

The page rendering apparatus provided by the embodiments of the present disclosure may execute the page rendering method provided by any embodiment of the present disclosure, and has corresponding functional modules and beneficial effects for executing the method.

It should be noted that the units and modules included in the above apparatus are only divided according to functional logic, but are not limited to the above division, as long as the corresponding functions can be realized; in addition, the specific names of the functional units are only for the convenience of distinguishing from each other, and are not intended to limit the protection scopes of the embodiments of the present disclosure.

FIG. 6 is a schematic structural diagram of an electronic device according to an embodiment of the present disclosure. Reference is made to FIG. 6 below, which illustrates a schematic structural diagram of an electronic device 500 (such as a terminal device or a server in FIG. 6) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), an in-vehicle terminal (such as an in-vehicle navigation terminal), and fixed terminals such as a digital TV and a desktop computer. The electronic device shown in FIG. 6 is only an example, and should not impose any limitation on the function and use scope of the embodiments of the present disclosure.

As shown in FIG. 6, the electronic device 500 may include a processing apparatus (such as a central processing unit, a graphics processing unit, etc.) 501, which may perform various appropriate actions and processing according to a program stored in a read-only memory (ROM) 502 or a program loaded from a storage apparatus 508 into a random access memory (RAM) 503. In the RAM 503, various programs and data necessary for the operation of the electronic device 500 are also stored. The processing apparatus 501, the ROM 502, and the RAM 503 are connected to each other through a bus 504. An input/output (I/O) interface 505 is also connected to the bus 504.

Generally, the following devices may be connected to the I/O interface 505: an input device 506, including, for example, a touch screen, a touchpad, a keyboard, a mouse, a camera, a microphone, an accelerometer, a gyroscope, etc.; an output device 507, including, for example, a liquid crystal display (LCD), a speaker, a vibrator, etc.; a storage device 508, including, for example, a magnetic tape, a hard disk, etc.; and a communication device 509. The communication device 509 may allow the electronic device 500 to perform wireless or wired communication with other devices to exchange data. Although FIG. 6 shows an electronic device 500 having various devices, it should be understood that not all of the illustrated devices are required to be implemented or provided. Alternatively, more or fewer devices may be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from the network through the communication device 509, or installed from the storage device 508, or installed from the ROM 502. When the computer program is executed by the processing device 501, the above functions defined in the method of the embodiments of the present disclosure are executed.

The names of messages or information exchanged between apparatuses in the implementations of the present disclosure are only used for illustration, and are not intended to limit the scope of these messages or information.

The electronic device provided by the embodiments of the present disclosure belongs to the same inventive concept as the page rendering method provided by the above embodiments. For the technical details not described in detail in this embodiment, reference may be made to the above embodiments, and this embodiment has the same beneficial effects as the above embodiments.

An embodiment of the present disclosure provides a computer storage medium, which stores a computer program, and when the program is executed by a processor, the page rendering method provided by the above embodiments can be implemented.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in conjunction with an instruction execution system, apparatus or device. In the present disclosure, the computer-readable signal medium may include a data signal propagated in baseband or as part of a carrier wave, and computer-readable program codes are carried in the data signal. The data signal propagated in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus or device. The program codes contained on the computer-readable medium may be transmitted by any suitable medium, including but not limited to an electrical wire, a fiber-optic cable, radio frequency (RF), etc., or any suitable combination thereof.

In some implementations, the client and the server may communicate using any currently known or future developed network protocol such as the Hypertext Transfer Protocol (HTTP), and may be interconnected with any form or medium of digital data communication (for example, a communication network). Examples of the communication network include a Local Area Network (LAN), a Wide Area Network (WAN), an internet (for example, the Internet), a peer-to-peer network (for example, an ad hoc network), and any currently known or future developed network.

The above computer-readable medium may be included in the above electronic device; or may exist alone without being assembled into the electronic device.

The above computer-readable medium carries one or more programs, and when the one or more programs are executed by the electronic device, the electronic device is caused to:

The above computer-readable medium carries one or more programs, and when the one or more programs are executed by the electronic device, the electronic device is caused to: monitor a scrolling operation triggered by a user on a current page, and determine a visible region based on the monitored scrolling operation, wherein the scrolling operation includes lateral scrolling or longitudinal scrolling; acquire a plurality of pieces of target service data corresponding to the visible region, where the plurality of pieces of target service data have a topological structure relationship thereamong; determine position information of the plurality of pieces of target service data in the visible region according to the topological structure relationship; and render the plurality of pieces of target service data to the current page for display based on the position information.

The computer program codes for performing the operations of the present disclosure may be written in one or more programming languages or a combination thereof, where the above programming languages include object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any kind of network, including a Local Area Network (LAN) or a Wide Area Network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the unit does not constitute a limitation of the unit itself under certain circumstances. For example, the first acquisition unit may also be described as “a unit for acquiring at least two Internet Protocol addresses”.

The functions described herein above may be performed, at least partially, by one or more hardware logic components. For example, without limitation, exemplary types of hardware logic components that may be used include: a Field-Programmable Gate Array (FPGA), an Application Specific Integrated Circuit (ASIC), an Application Specific Standard Product (ASSP), a System on a Chip (SOC), a Complex Programmable Logical Device (CPLD), etc.

In the context of the present disclosure, a machine-readable medium may be a tangible medium that may contain or store a program for use by or in conjunction with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The description of the technical principles used is presented. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosure concept, for example, the technical solutions formed by replacing the above features with the technical features with similar functions disclosed in the present disclosure (but not limited to).

In addition, although operations are depicted in a particular order, it should not be construed as requiring these operations to be performed in the particular order shown or in a sequential order. Under certain circumstances, multitasking and parallel processing may be advantageous. Similarly, although the above discussion contains several specific implementation details, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only exemplary forms of implementing the claims.

1. A page rendering method, comprising:
monitoring a scrolling operation triggered by a user on a current page, and determining a visible region based on the monitored scrolling operation, wherein the scrolling operation comprises lateral scrolling or longitudinal scrolling;
acquiring a plurality of pieces of target service data corresponding to the visible region, wherein the plurality of pieces of target service data have a topological structure relationship thereamong;
determining position information of the plurality of pieces of target service data in the visible region according to the topological structure relationship; and
rendering the plurality of pieces of target service data to the current page for display based on the position information.

2. The method according to claim 1, wherein determining the position information of the plurality of pieces of target service data in the visible region according to the topological structure relationship comprises:
determining hierarchical information of each piece of target service data according to the topological structure relationship; and
determining position information of a cell wherein the target service data is located according to the hierarchical information, wherein the cell is a row cell or a column cell; and
rendering the plurality of pieces of service data to the current page for display based on the position information comprises:
rendering the target service data to a corresponding cell based on the position information.

3. The method according to claim 2, wherein when the cell is the row cell, the position information of the cell comprises longitudinal position information and lateral indent information, and when the cell is the column cell, the position information of the cell comprises lateral position information and longitudinal indent information.

4. The method according to claim 1, wherein, before monitoring the scrolling operation triggered by the user on the current page, the method further comprises:
receiving an initial service data topology configured by the user; and
fusing the initial service data topology with a system service data topology to obtain a target service data topology.

5. The method according to claim 4, wherein receiving the initial service data topology configured by the user comprises:
displaying the system service data topology in a resource panel;
dragging at least one piece of service data selected by the user from the resource panel to a configuration panel based on a drag-and-drop operation of the user;
receiving a hierarchical relationship configured by the user for the at least one piece of service data in the configuration panel; and
generating the initial service data topology based on the hierarchical relationship.

6. The method according to claim 5, wherein receiving the hierarchical relationship configured by the user for the at least one piece of service data in the configuration panel comprises:
receiving a movement operation of the user for the at least one piece of service data in the configuration panel; and
configuring the hierarchical relationship based on the movement operation.

7. The method according to claim 4, wherein fusing the initial service data topology with the system service data topology to obtain the target service data topology comprises:
extracting a plurality of service data topology subgraphs that meet a set condition from the system service data topology, wherein the set condition is that a root node of the service data topology subgraph is the same as a root node of the initial service data topology;
filtering the plurality of service data topology subgraphs to obtain first candidate service data topology subgraphs;
merging the first candidate service data topology subgraphs to obtain a second candidate service data topology subgraph; and
cropping the second candidate service data topology subgraph based on the initial service data topology to obtain the target service data topology.

8. The method according to claim 7, wherein filtering the plurality of service data topology subgraphs to obtain the first candidate service data topology subgraph comprises:
filtering out a service data topology subgraph that does not contain the initial service data topology.

9. The method according to claim 7, wherein merging the first candidate service data topology subgraphs to obtain the second candidate service data topology subgraph comprises:
deduplicating and merging the first candidate service data topology subgraphs from a root node to obtain the second candidate service data topology subgraph; and
cropping the second candidate service data topology subgraph based on the initial service data topology to obtain the target service data topology comprises:
acquiring a corresponding node between the initial service data topology and the second candidate service data topology subgraph; and
cropping out an N-level child node of the corresponding node of the second candidate service data topology subgraph to obtain the target service data topology, wherein N is a positive integer greater than 1.

10. The method according to claim 1, wherein the target service data comprises target identification information and target attribute information, and acquiring the plurality of pieces of target service data corresponding to the visible region comprises:
loading identification information of full amount of service data of the current page;
acquiring a plurality of pieces of target identification information corresponding to the visible region from the identification information based on a set mapping relationship, wherein the set mapping relationship is a mapping relationship between the visible region and the service data; and
loading a plurality of pieces of target attribute information based on the plurality of pieces of target identification information.

11. The method according to claim 10, wherein after loading the plurality of pieces of target attribute information based on the plurality of pieces of target identification information, the method further comprises:
determining a predicted visible region; and
loading prediction attribute information corresponding to the predicted visible region.

12. (canceled)

13. An electronic device, comprising:
one or more processors; and
a storage device, configured to store one or more programs,
wherein the one or more programs, when executed by the one or more processors, cause the one or more processors to implement:
monitoring a scrolling operation triggered by a user on a current page, and determining a visible region based on the monitored scrolling operation, wherein the scrolling operation comprises lateral scrolling or longitudinal scrolling;
acquiring a plurality of pieces of target service data corresponding to the visible region, wherein the plurality of pieces of target service data have a topological structure relationship thereamong;
determining position information of the plurality of pieces of target service data in the visible region according to the topological structure relationship; and
rendering the plurality of pieces of target service data to the current page for display based on the position information.

14. A non-transitory storage medium comprising computer-executable instructions, wherein the computer-executable instructions, when executed by a computer processor, are used to execute:
monitoring a scrolling operation triggered by a user on a current page, and determining a visible region based on the monitored scrolling operation, wherein the scrolling operation comprises lateral scrolling or longitudinal scrolling;
acquiring a plurality of pieces of target service data corresponding to the visible region, wherein the plurality of pieces of target service data have a topological structure relationship thereamong;
determining position information of the plurality of pieces of target service data in the visible region according to the topological structure relationship; and
rendering the plurality of pieces of target service data to the current page for display based on the position information.

15. The electronic device according to claim 13, wherein determining the position information of the plurality of pieces of target service data in the visible region according to the topological structure relationship comprises:
determining hierarchical information of each piece of target service data according to the topological structure relationship; and
determining position information of a cell wherein the target service data is located according to the hierarchical information, wherein the cell is a row cell or a column cell; and
rendering the plurality of pieces of service data to the current page for display based on the position information comprises:
rendering the target service data to a corresponding cell based on the position information.

16. The electronic device according to claim 13, wherein, before monitoring the scrolling operation triggered by the user on the current page, wherein the one or more programs, when executed by the one or more processors, cause the one or more processors to further implement:
receiving an initial service data topology configured by the user; and
fusing the initial service data topology with a system service data topology to obtain a target service data topology.

17. The electronic device according to claim 16, wherein fusing the initial service data topology with the system service data topology to obtain the target service data topology comprises:
extracting a plurality of service data topology subgraphs that meet a set condition from the system service data topology, wherein the set condition is that a root node of the service data topology subgraph is the same as a root node of the initial service data topology;
filtering the plurality of service data topology subgraphs to obtain first candidate service data topology subgraphs;
merging the first candidate service data topology subgraphs to obtain a second candidate service data topology subgraph; and
cropping the second candidate service data topology subgraph based on the initial service data topology to obtain the target service data topology.

18. The electronic device according to claim 13, wherein the target service data comprises target identification information and target attribute information, and acquiring the plurality of pieces of target service data corresponding to the visible region comprises:
loading identification information of full amount of service data of the current page;
acquiring a plurality of pieces of target identification information corresponding to the visible region from the identification information based on a set mapping relationship, wherein the set mapping relationship is a mapping relationship between the visible region and the service data; and
loading a plurality of pieces of target attribute information based on the plurality of pieces of target identification information.

19. The non-transitory storage medium according to claim 14, wherein determining the position information of the plurality of pieces of target service data in the visible region according to the topological structure relationship comprises:
determining hierarchical information of each piece of target service data according to the topological structure relationship; and
determining position information of a cell wherein the target service data is located according to the hierarchical information, wherein the cell is a row cell or a column cell; and
rendering the plurality of pieces of service data to the current page for display based on the position information comprises:
rendering the target service data to a corresponding cell based on the position information.

20. The non-transitory storage medium according to claim 14, wherein, before monitoring the scrolling operation triggered by the user on the current page, wherein the one or more programs, when executed by the one or more processors, cause the one or more processors to further implement:
receiving an initial service data topology configured by the user; and
fusing the initial service data topology with a system service data topology to obtain a target service data topology.

21. The non-transitory storage medium according to claim 14, wherein the target service data comprises target identification information and target attribute information, and acquiring the plurality of pieces of target service data corresponding to the visible region comprises:
loading identification information of full amount of service data of the current page;
acquiring a plurality of pieces of target identification information corresponding to the visible region from the identification information based on a set mapping relationship, wherein the set mapping relationship is a mapping relationship between the visible region and the service data; and
loading a plurality of pieces of target attribute information based on the plurality of pieces of target identification information.
